(19) United States
(12) Patent Application Publication
(10) Pub. No.: US 2014/0345540 A1
(43) Pub. Date: Nov. 27, 2014

(54) ANIMAL RESTRAINT FOR A VEHICLE

(71) Applicant: Donald Wayne Van Orman, Elma, WA (US)

(72) Inventor: Donald Wayne Van Orman, Elma, WA (US)

(73) Assignee: PET SECURE LLC, Elma, WA (US)

(21) Appl. No.: 14/285,319

(22) Filed: May 22, 2014

Related U.S. Application Data
(60) Provisional application No. 61/826,404, filed on May 22, 2013.

(51) Int. Cl. B60R 22/10; A01K 27/00

(52) U.S. Cl. CPC B60R 22/10; A01K 27/003
USPC 119/771

(57) ABSTRACT

A disclosed restraint secures an animal to a pair of vehicle seat anchors. The restraint includes a first strap and a second strap. Each of the first and second straps has a fixed loop formed at one end and a bolt snap secured to the other end. A ring passes through the fixed loops to couple the first strap to the second strap. Each of the bolt snaps is detachably securable to one of the pair of vehicle seat anchors. The restraint further includes a leash comprising a third strap with a bolt snap attached to each end. The leash is detachably coupled to the ring so that the first and second straps limit movement of the leash.

### CROSS-REFERENCE TO RELATED APPLICATION

This application claims the benefit of U.S. Provisional Application No. 61/826,404, filed May 22, 2013, the entire disclosure of which is hereby incorporated by reference herein.

### BACKGROUND

Transporting an animal, such as a dog, within a vehicle can be hazardous if the animal is not properly restrained. An unrestrained animal can move about within the vehicle, potentially distracting the driver or interfering with the driver's ability to safely operate the vehicle. In addition, similar to a passenger not wearing a seatbelt, an unrestrained animal risks greater injury in the event of an accident. Accordingly, there exists a need for a device to restrain an animal within a vehicle.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A disclosed embodiment of a restraint secures an animal to a pair of vehicle seat anchors. The restraint includes a first strap and a second strap. Each of the first and second straps has a fixed loop formed at one end and a bolt snap secured to the other end. A ring passes through the fixed loops to couple the first strap to the second strap. Each of the bolt snaps is detachably securable to one of the pair of vehicle seat anchors. The restraint further includes a leash comprising a third strap with a bolt snap attached to each end. The leash is detachably coupled to the ring so that the first and second straps limit movement of the leash.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows an isometric view of a rear vehicle seat with anchors;

FIG. 2 shows a first embodiment of an animal restraint device for a vehicle; and

FIG. 3 shows a second embodiment of an animal restraint device for a vehicle.

### DETAILED DESCRIPTION

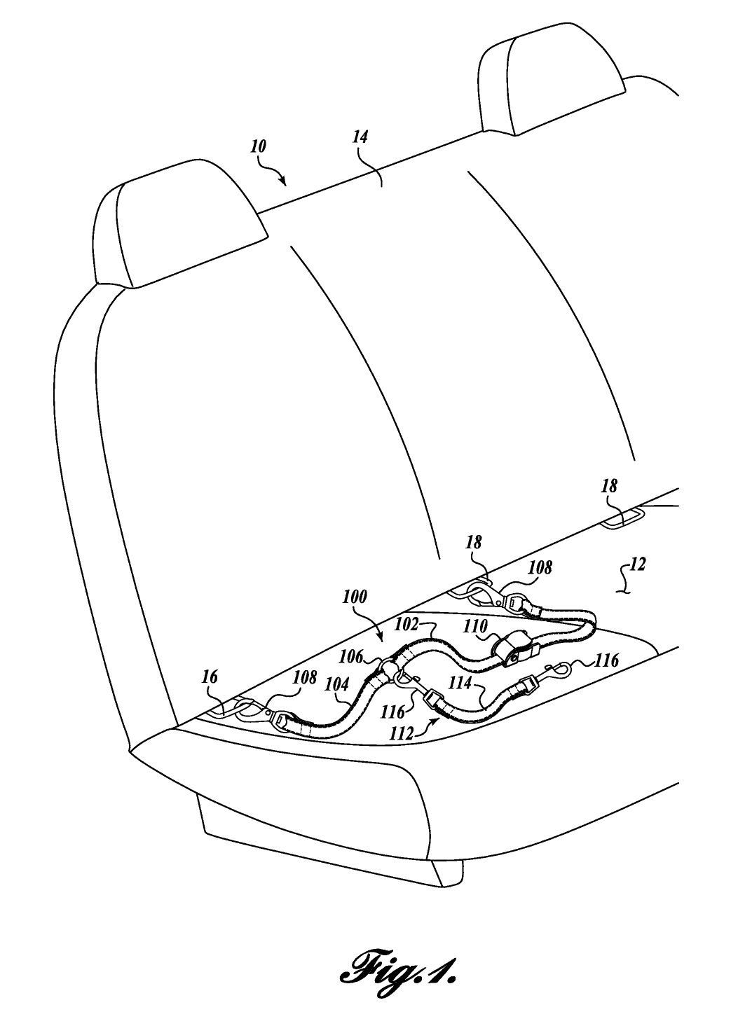

FIG. 1 shows an exemplary rear seat assembly 10 typical to modern vehicles, such as cars, mini-vans, SUVs, and the like. The seat assembly 10 includes a horizontal seat 12 and a vertical back 14. The bench configuration provides seating for a passenger on each side, and an additional passenger in the middle. The seat assembly 10 also includes a plurality of anchors 16 and 18 disposed between the horizontal seat 12 and the vertical back 14.

The anchors 16 and 18 provide attach points that enable a user to secure a child seat to the seat assembly 10 in order to safely transport children and infants in the vehicle. In the illustrated embodiment, an outboard anchor 16 and an inboard anchor 18 are provided at each of the passenger side and the driver side of the seat assembly 10. Each anchor comprises a bar or loop fixedly coupled to the vehicle that provides a secure attach point to couple a child seat to the seat assembly. To secure a child seat to the seat assembly 10, the user places the child seat on the seat assembly on the driver side or the passenger side. The child seat includes attachment straps that are then secured to the corresponding anchors 16 and 18.

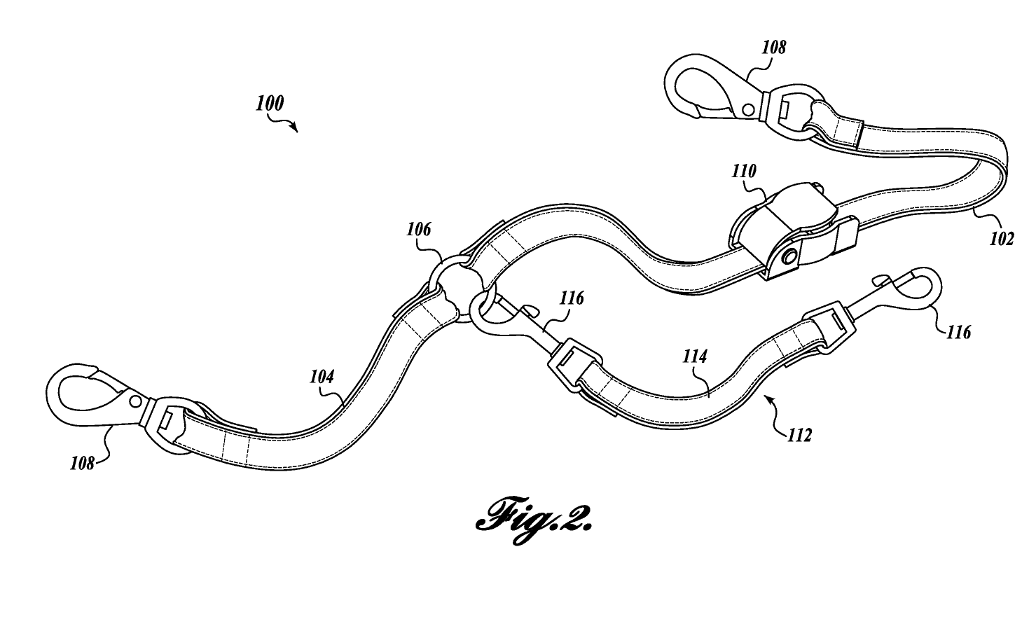

Referring now to FIG. 2, a first embodiment of restraint 100 is shown. The restraint includes a first strap 102 coupled at a first end to the first end of a second strap 104 by a ring 106. The first and second straps 102 and 104 are preferably made from a durable, flexible material such as nylon webbing or the like. It will be appreciated that the straps can be formed from other materials, such as polypropylene, polyester, cotton, or any other suitable material. Each strap 102 and 104 is attached to the ring 106 by a loop formed in the first end of the strap. In the illustrated embodiment, the end of the strap is passed through the ring and doubled back on itself to form the loop. The loop is maintained by securing the end of the strap to the body of the strap by stitching or other suitable means.

The ring 106 is formed from a metal, a polymer, or any other material having suitable strength and durability. The ring 106 connects the respective first ends of the first strap 102 and second strap 104 so that the straps 102 and 104 act as a single strap with the ring 106 disposed in the middle.

Still referring to FIG. 2, a bolt snap 108 is coupled to the second end of each strap 102 and 104. Bolt snaps are known in the art to releasably couple a strap to a secure ring, for example, to attach a leash to a dog collar. In the disclosed embodiment, the bolt snaps 108 are sized and configured to releasably couple the restraint 100 to the anchors 16 and 18 of the seat assembly. The bolt snap 108 of the first strap 102 is secured to an adjustable loop formed on the second end of the first strap. In this regard, the first strap passes through the ring end of the bolt snap 108 and is adjustably secured back to the first strap with an adjustment buckle 110 that is known in the art. Thus, the length of the first strap 102 and, therefore, the combined length of the first and second straps 102 and 104, can be selectively adjusted. The bolt snap 108 of the second strap 104 is secured to the second end of the second strap by a fixed loop formed in the second end of the second strap. The second loop passes through the ring end of the bold snap 108 to fixedly couple the bolt snap to the second end of the second strap 104. It will be appreciated that any of the loops that secure the first and second straps 102 and 104 to the ring 106 or to the bolt snap 108 can be fixed or adjustable. Various combinations of fixed and adjustable straps are contemplated and should be considered within the scope of the present disclosure.

The restraint 100 further includes a leash 112 that includes a strap 114 with a bolt snap 116 coupled to each end thereof. The bolt snaps 116 are sized and configured so that at least one of the bolt snaps can be removably coupled to the ring 106 and the other bolt snap can be removably coupled to a typical dog collar or harness.

To secure an animal within the vehicle, the bolt snap 108 of the first strap 102 is attached to one of the outboard anchors 16 of the seat assembly 10. The bolt snap 108 of the second strap 104 is attached to the corresponding inboard anchor 18 of the seat assembly, so that the first and second straps 102, and 104, connected by the ring 106, span the distance between the inboard and outboard anchors 16 and 18 the passenger side or driver side of the seat assembly 10. For embodiments in which the first and/or second straps are have adjustable lengths, the strap lengths are optionally adjusted so that combined length of the first and second straps corresponds to the distance between the anchors 16 and 18.

With the first and second straps secured to the anchors, one end of the leash 112 is secured to the first and second straps by coupling one of the leash bolt snaps 116 to the ring 106. The other leash bolt snap 116 is coupled to the harness or collar of the animal, thereby containing the animal to the portion of the seat assembly 10 located between the anchors 16 and 18.

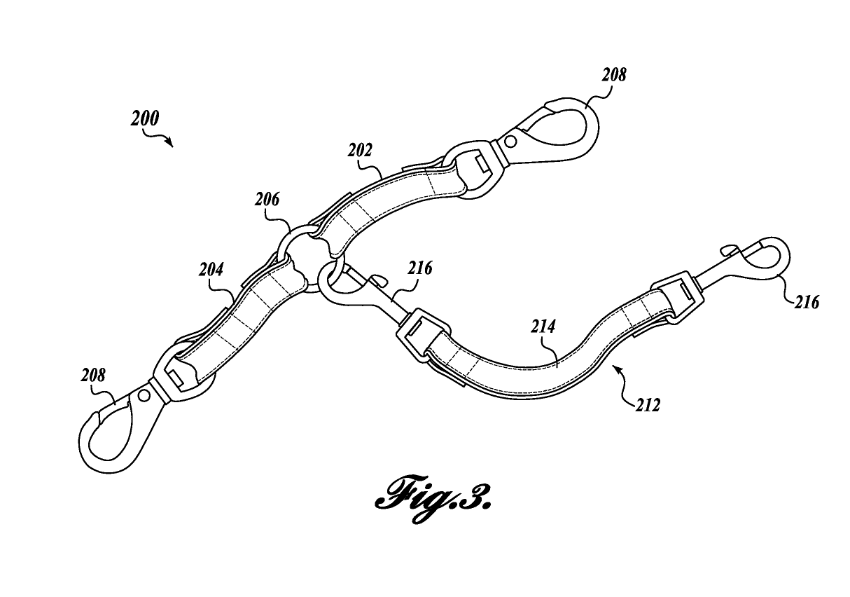

Referring now to FIG. 3, a second embodiment of a restraint 200 is shown wherein reference numbers 2XX for elements of the second embodiment correspond to similar reference numbers 1XX of the first embodiment. The second embodiment is similar to the first embodiment except for the lengths of the first and second straps 202 and 204. In the second embodiment, the lengths of the first and second straps 202 and 204 are shorter so that the combined length of the first and second straps spans the distance between the inboard anchors 18. Thus, the restraint 200 is suitable for restraining an animal in the middle of the rear seat assembly 10. It will be appreciated that the lengths of the first and second straps can be altered to span any two of the anchors 16 and 18 to secure the animal within the vehicle.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A restraint for securing an animal to a pair of vehicle seat anchors, the restraint comprising:
(a) a first strap, a first loop formed in a first end of the first strap, and a first bolt snap coupled to a second end of the first strap;
(b) a second strap, a second loop being formed in a first end of the second strap, and a second bolt snap coupled to a second end of the second strap;
(c) a ring passing through the first loop and the second loop to connect the first and second straps; and
(d) a leash comprising a third strap having a first end coupled to the ring, a third bolt snap being coupled to a second end of the leash, the third bolt snap being selectively securable to an animal collar; wherein each of the first and second bolt snaps are detachably securable to one of the pair of vehicle anchors to limit movement of the third bolt snap.

2. The restraint of claim 1, wherein the first strap has a selectively adjustable length.

3. The restraint of claim 2, the first strap comprising an adjustment buckle to enable selective adjustment of the length.

4. The restraint of claim 1, wherein the second end of the first strap comprises a third loop to couple the first bolt snap to the first strap.

5. The restraint of claim 4, wherein the second end of the second strap comprises a fourth loop to couple the second bolt snap to the second strap.
